(19) United States
(12) Patent Application Publication
(10) Pub. No.: US 2025/0293471 A1
(43) Pub. Date: Sep. 18, 2025

(54) Connector Assembly

(71) Applicant: Tyco Electronics AMP Korea Co., Ltd., Gyeongsan (KR)

(72) Inventors: Jae Yong Bae, Gyeongsan-Si (KR); Kyu-Taek Jung, Gyeongsan-Si (KR)

(73) Assignee: Tyco Electronics AMP Korea Co., Ltd., Gyeongsan (KR)

(21) Appl. No.: 19/082,334

(22) Filed: Mar. 18, 2025

(30) Foreign Application Priority Data
Mar. 18, 2024 (KR) 10-2024-0037403
Feb. 19, 2025 (KR) 10-2025-0021778

(51) Int. Cl. H01R 25/14; H01R 13/447; H01R 13/506; H01R 13/639; H01R 103/00

(52) U.S. Cl. CPC H01R 25/145; H01R 13/447; H01R 13/506; H01R 13/639; H01R 2103/00

(57) ABSTRACT

A connector assembly includes a connector housing having a housing main body, a plurality of cable insertion grooves formed in the housing main body, a locking lance protruding into the cable insertion grooves, a retreat space providing a space allowing the locking lance to elastically deform and retreat, and a bus bar support protruding inward from an inner wall of the housing main body. The connector assembly includes a joint terminal having a plurality of coupling bars and a connection bar physically and electrically connecting the coupling bars and seated in a bus bar seating groove formed in the bus bar support. The connector assembly has a connector cover including a cover plate closing one side of each of the cable insertion grooves and a lance support protruding from the cover plate and inserted into the retreat space to reduce elastic deformation of the locking lance.

### CROSS-REFERENCE TO RELATED APPLICATION

This application claims the benefit of the filing date under 35 U.S.C. § 119(a)-(d) of Korean Patent Application No. 10-2024-0037403, filed on Mar. 18, 2024, and Korean Patent Application No. 10-2025-0021778, filed on Feb. 19, 2025.

### FIELD OF THE INVENTION

The following disclosure relates to a connector assembly.

### BACKGROUND OF THE INVENTION

A connector is a type of electrical component that may connect or disconnect an electrical connection. Connectors are used in various electronic and mechanical devices, such as automobiles and household appliances, to facilitate electrical and/or physical connections between a plurality of electronic components.

Technologies are required to prevent damage to connection terminals by assisting in the alignment of the connection terminals of a connector. Additionally, technologies for producing compact connectors are required.

The above description is information the inventor(s) acquired during the course of conceiving the present disclosure, or already possessed at the time, and is not necessarily art publicly known before the present application was filed.

### SUMMARY OF THE INVENTION

A connector assembly includes a connector housing having a housing main body, a plurality of cable insertion grooves formed in the housing main body and respectively accommodating a plurality of external connection cables, a locking lance protruding into the plurality of cable insertion grooves to reduce separation of the plurality of external connection cables from the plurality of cable insertion grooves, a retreat space providing a space allowing the locking lance to elastically deform and retreat so that the plurality of external connection cables is insertable into the plurality of cable insertion grooves, and a bus bar support protruding inward from an inner wall of the housing main body. The connector assembly includes a joint terminal having a plurality of coupling bars respectively passing through a plurality of bar through grooves formed in the bus bar support and respectively coupled to the plurality of external connection cables, and a connection bar physically and electrically connecting the plurality of coupling bars and seated in a bus bar seating groove formed in the bus bar support. The connector assembly includes a connector cover including a cover plate closing one side of each of the plurality of cable insertion grooves and a lance support protruding from the cover plate and inserted into the retreat space to reduce elastic deformation of the locking lance in a direction of separation from the plurality of external connection cables.

### BRIEF DESCRIPTION OF THE DRAWINGS

The invention will now be described by way of example with reference to the accompanying figures, of which:

FIG. 1 is a perspective view of a connector assembly according to an embodiment;

FIG. 2 is an exploded perspective view of the connector assembly according to an embodiment;

FIG. 3 is a cross-sectional view of the connector assembly according to an embodiment;

FIG. 4 is a cross-sectional view of the connector assembly taken along the line I-I of FIG. 3;

FIG. 5 is a plan view of a housing main body according to an embodiment;

FIG. 6 is a plan view of a joint terminal inserted into the housing main body of FIG. 5, according to an embodiment; and

FIG. 7 is a cross-sectional perspective view of a partially cut-away portion of the connector assembly, according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or groups thereof but do not preclude the presence or addition of one or more other features, integers, steps, operations, elements, components, or groups thereof.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

Unless otherwise defined, all terms including technical and scientific terms used herein have the same meaning as commonly understood by one of ordinary skill in the art to which the embodiments belong. Terms defined in dictionaries generally used should be construed to have meanings matching with contextual meanings in the related art and are not to be construed as an ideal or excessively formal meaning unless otherwise defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the embodiments. Each of these terms is not used to define an essence, order, or sequence of corresponding components, but used merely to distinguish the corresponding components from other components. It should be noted that if one component is described as being “connected,” “coupled” or “joined” to another component, the former may be directly “connected,” “coupled,” and “joined” to the latter or “connected”, “coupled”, and “joined” to the latter via another component.

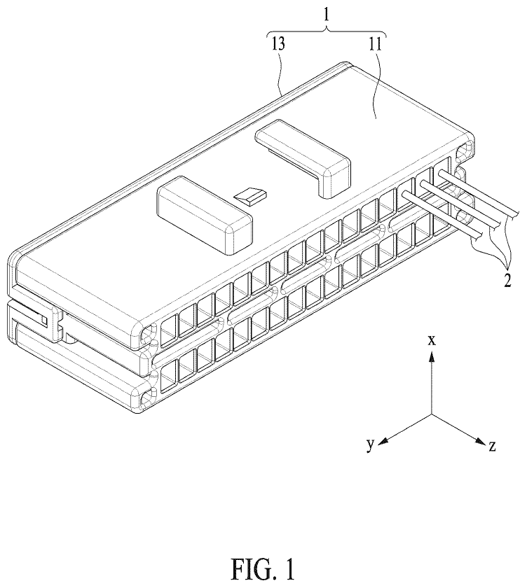

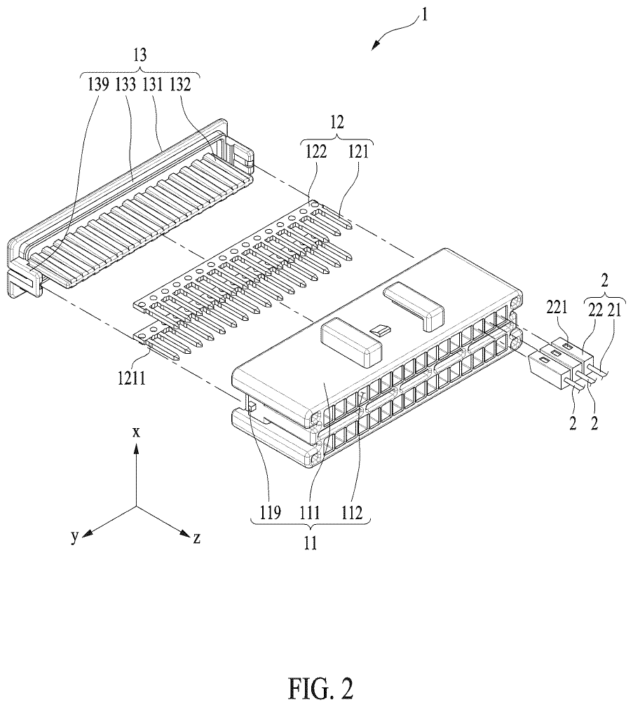

Referring to FIGS. 1 and 2, a connector assembly 1 according to an embodiment may electrically connect a plurality of external connection cables 2 to one another. For example, the connector assembly 1 may be referred to as a joint connector assembly 1. For example, when an electrical signal (e.g., power) is input from one connection cable 2 among the plurality of connection cables 2, the input electrical signal may be distributed or transmitted to the other connection cables 2 among the plurality of connection cables 2.

According to an embodiment, as shown in FIG. 2, a connection cable 2 may include a cable line 21 transmitting an electrical signal and a cable terminal 22 disposed at an end of the cable line 21 and physically and electrically connectable to a joint terminal 12 of the connector assembly 1. According to an embodiment, as described below, the cable terminal 22 may include a terminal locking groove 221 that may engage with an inner structure (e.g., a locking lance 114) of the connector assembly 1.

According to an embodiment, the connector assembly 1 may include a connector housing 11, the joint terminal 12, and a connector cover 13, as shown in FIG. 2. For example, the connector housing 11 may include a space to which the connection cable 2 and the joint terminal 12 may be inserted. For example, the joint terminal 12 may be provided in a state of being fixed to the connector housing 11 rather than the connector cover 13. For example, when the joint terminal 12 is provided in a state of being fixed to the connector cover 13, there may be difficulties in correctly aligning the joint terminal 12 and the connector housing 11 in the process of mounting the connector cover 13 to the connector housing 11. However, when the joint terminal 12 is provided in a state of being fixed to the connector housing 11, the above-described work difficulties may be reduced and the force required to fasten the connector cover 13 to the connector housing 11 may be reduced.

According to an embodiment, the connector housing 11 may include a housing main body 111, a plurality of cable insertion grooves 112 formed in the housing main body 111 and configured to respectively accommodate the plurality of external connection cables 2, and a housing-side coupling portion that may be coupled to the connector cover 13.

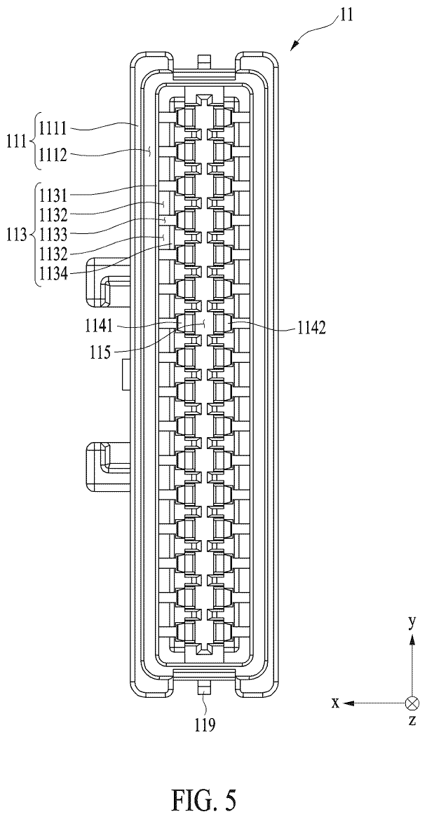

According to an embodiment, the joint terminal 12 may include a plurality of coupling bars 121 respectively connectable to the plurality of connection cables 2 and a connection bar 122 that physically and electrically connects the plurality of coupling bars 121, as shown in FIG. 2. According to an embodiment, a fitting portion 1211 may be formed at a side surface of the coupling bar 121. According to an embodiment, the fitting portion 1211 may enable the joint terminal 12 to be stably fixed to the connector housing 11 by engaging an inner wall of the connector housing 11 (e.g., a bar through groove 1133 of FIG. 5) using an interference fit.

According to an embodiment, as shown in FIG. 2, the connector cover 13 may include a cover plate 131 capable of closing one side (e.g., a portion positioned on the opposite side (e.g., −z-axis direction) of an opening into which the connection cable 2 is inserted), a lance support 132 protruding from the cover plate 131, a protruding partition wall 133 protruding from the cover plate 131, and a cover-side coupling portion 139 coupled to the connector housing 11. According to an embodiment, the protruding partition wall 133 may have a shape surrounding the space between the outermost edge portion of the cover plate 131 and the lance support 132. According to an embodiment, the cover-side coupling portion 139 may be coupled to a housing-side coupling portion 119, which may reduce separation of the connector cover 13 from the connector housing 11. For example, the cover-side coupling portion 139 may include a groove or hole shape, and the housing-side coupling portion 119 may include a protrusion shape, but embodiments are not limited thereto, and the two may be designed the other way around.

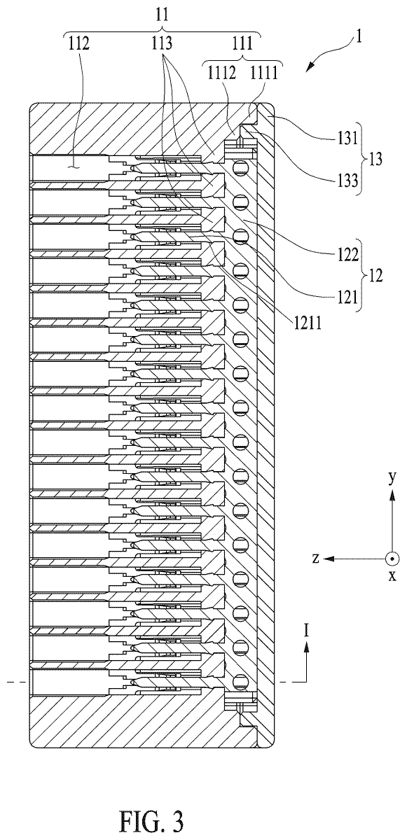

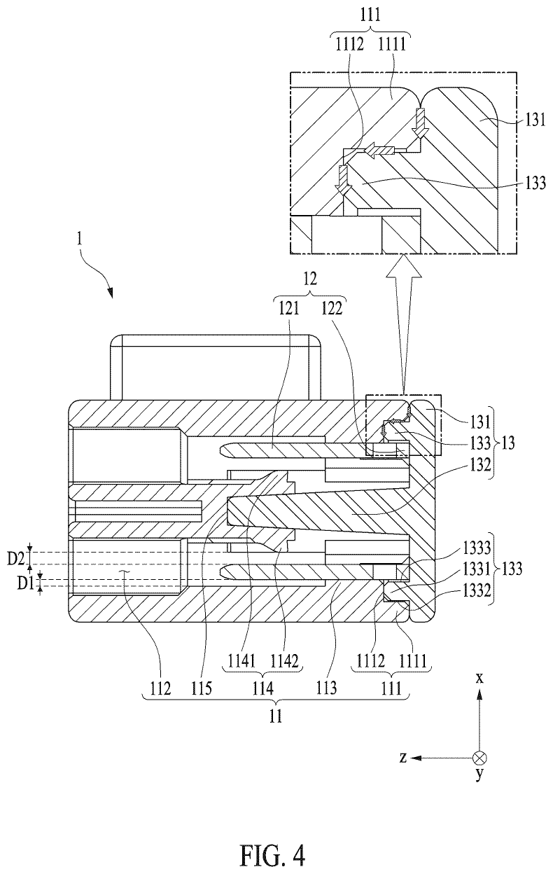

Referring to FIGS. 3 and 4, the connector housing 11 according to an embodiment may include the housing main body 111, a cable insertion groove 112, a bus bar support 113, the locking lance 114, and a retreat space 115. According to an embodiment, the housing main body 111 may include a main body outer wall 1111 forming an exterior of the connector housing 11 and a partition wall accommodating groove 1112 formed to be stepped inward from the main body outer wall 1111 to accommodate a portion (e.g., the protruding partition wall 133) of the connector cover 13. According to an embodiment, the partition wall accommodating groove 1112 may have a shape facing each of a protruding end surface 1331 and a partition wall outer surface 1332 of the protruding partition wall 133. According to this structure, the stability of the coupling structure between the connector cover 13 and the connector housing 11 may be improved, and as shown by the arrows in FIG. 4, the entry path of foreign substances (e.g. dust) flowing in from the outside may be bent in multiple stages, thereby improving dustproof performance.

According to an embodiment, the cable insertion groove 112 may be formed to penetrate the connector housing 11 in the longitudinal direction (e.g., +/−z-axis direction) of the coupling bar 121 of the joint terminal 12. For example, the joint terminal 12 may be inserted from one side (e.g., −z-axis direction) of the cable insertion groove 112, and the connection cable 2 may be inserted from the other side (e.g., +z-axis direction) of the cable insertion groove 112 and coupled to the joint terminal 12. In this state, the connector cover 13 may be coupled to one side (e.g., −z-axis direction) of the cable insertion groove 112.

According to an embodiment, the bus bar support 113 may protrude inward from the inner wall of the housing main body 111 and may support the joint terminal 12. The bus bar support 113 may include a structure that is in surface contact with at least a portion of the joint terminal 12, thereby allowing the joint terminal 12 to be stably supported inside the connector housing 11. An exemplary structure of the bus bar support 113 is described below with reference to FIG. 5 and below.

According to an embodiment, as shown in FIG. 4, the locking lance 114 may be formed to protrude into the cable insertion groove 112 to reduce the connection cable 2 from being separated from the cable insertion groove 112. For example, the locking lance 114 may include a first lance portion 1141 including a shape protruding from the center of the housing main body 111 toward an inner wall on one side (e.g., in the +x-axis direction) of the housing main body 111 and a second lance portion 1142 including a shape protruding from the center of the housing main body 111 toward an inner wall on the other side (e.g., in the −x-axis direction) of the housing main body 111 positioned on the opposite side (e.g., in the −x-axis direction) of the inner wall on the one side. For example, the first lance portion 1141 and the second lance portion 1142 may have shapes that are mutually symmetrical with respect to one retreat space 115.

According to an embodiment, the retreat space 115 may provide a space in which the locking lance 114 may retreat so that the locking lance 114 may be elastically deformed to allow the connection cable 2 to be inserted into the cable insertion groove 112. For example, the retreat space 115 may be formed between the first lance portion 1141 and the second lance portion 1142. With this structure, there is no need to individually provide the retreat space 115 for each of the first lance portion 1141 and the second lance portion 1142, and the first lance portion 1141 and the second lance portion 1142 may retreat using a single retreat space 115. For example, in the connector assembly 1 of the same size, when the retreat space 115 is individually provided for each of the first lance portion 1141 and the second lance portion 1142, the volume of each retreat space 115 becomes small. In this case, a problem may arise in which the creation of the retreat space 115 becomes challenging. According to an embodiment, by manufacturing one retreat space 115 corresponding to the sum of the volumes of each of the retreat spaces 115 described above, it may be possible to provide a space in which the first lance portion 1141 and the second lance portion 1142 may retreat, thereby improving the case of manufacturing the retreat space 115. For example, when the connector housing 11 is manufactured by injection molding and the space between the structures of a mold is insufficient, the quality of a molded result is likely to deteriorate. However, according to the embodiment described above, since this issue may be reduced, yield of good quality of the connector housing 11 may be improved, and as a result, the overall manufacturing cost may be reduced. In addition, as the volume of the retreat space 115 increases, the thickness of the lance support 132 inserted into the retreat space 115 may be increased, so a mold for manufacturing the lance support 132 may be easily manufactured. For example, when the retreat space 115 is individually provided for each of the first lance portion 1141 and the second lance portion 1142, the lance support 132 may have to be provided in plurality, and the thickness of the lance support 132 may have to be relatively thin, which may increase the difficulty of mold manufacturing. Therefore, considering the difficulty of mold manufacturing, the retreat space 115 for each of the first lance portion 1141 and the second lance portion 1142 may need to be designed to have a predetermined volume or more, which may increase the size of the entire connector assembly 1. According to an embodiment, providing a structure in which one retreat space 115 corresponds to a plurality of lance portions (e.g., 1141 and 1142) may eventually improve the yield of good products and miniaturize the size of the entire connector assembly 1.

According to an embodiment, the joint terminal 12 may include the plurality of coupling bars 121 respectively passing through a plurality of bar through grooves 1133 (see FIG. 5) formed in the bus bar support 113 and the connection bar 122 seated in the bus bar seating groove 1132 (see FIG. 5) formed in the bus bar support 113. For example, the fitting portion 1211 formed in the coupling bar 121 may engage with the bus bar support 113 using an interference fit. With this structure, even when the connector cover 13 is not coupled to the connector housing 11, the joint terminal 12 may be stably inserted and fixed to the connector housing 11. An exemplary connection structure between the joint terminal 12 and the bus bar support 113 is described below with reference to FIG. 5 and below.

According to an embodiment, as shown in FIG. 4, a shortest distance D1 from the coupling bar 121 to the inner wall of the connector housing 11 excluding the bus bar support 113 may be less than a shortest distance D2 from the coupling bar 121 to the locking lance 114. With this structure, while securing a space for inserting the cable terminal 22 of the connection cable 2 (see FIG. 2) between the coupling bar 121 and the inner wall of the connector housing 11, the joint terminal 12 may be positioned close to the inner wall of the connector housing 11, that is, far from the locking lance 114. In addition, the bus bar support 113 is formed in a region adjacent to the joint terminal 12 in order to support the joint terminal 12, and as a result, the position in which the bus bar support 113 is formed may be sufficiently far from the locking lance 114. Therefore, by securing sufficient space between the bus bar support 113 and the locking lance 114, for example, when the connector housing 11 is manufactured by injection molding, yield of good quality of the connector housing 11 may be improved, and as a result, the overall manufacturing cost may be reduced.

According to an embodiment, the connector cover 13 may include the cover plate 131, the lance support 132, and the protruding partition wall 133, as shown in FIG. 4.

According to an embodiment, the lance support 132 may reduce clastic deformation of the locking lance 114 in the direction of separation from the connection cable 2 by being inserted into the retreat space 115. For example, in order to replace the function of the lance support 132, a position assurance structure may be employed that is inserted from the outside by penetrating the connector housing 11 in a direction (e.g., +/−x-axis direction) perpendicular to the longitudinal direction (e.g., +/−z-axis direction) of the connection cable 2 while the connection cable 2 is inserted into the cable insertion groove 112. In order to manufacture the connector housing 11 having such a structure by injection molding, two molds that are separately provided in the longitudinal direction (e.g., +/−x-axis direction) of the cable insertion groove 112 and at least one slide core that slides in a direction (e.g., +/−x-axis direction) perpendicular to the longitudinal direction of the cable insertion groove 112 may be required. In addition, according to an embodiment, the connector housing 11 may not include a hole formed in a direction (e.g., +/−x-axis direction) perpendicular to an insertion direction (e.g., +/−z-axis direction) in which the joint terminal 12 is inserted into the connector housing 11, as illustrated. In other words, the connector assembly 1 according to an embodiment may prevent the locking lance 114 from being separated from the connection cable 2 by using the lance support 132 even without the position assurance structure described above. Since the connector housing 11 with such a structure may be manufactured by injection molding using only two molds even without the slide core described above, the manufacturing cost may be reduced.

For example, the lance support 132 may have a shape that tapers in cross-sectional area toward a protruding direction (e.g., +z-axis direction). With such a shape, the lance support 132 may be easily inserted into the retreat space 115, and the connector cover 13 may be properly aligned and coupled to the connector housing 11 during the process in which the lance support 132 is inserted into the retreat space 115.

According to an embodiment, as shown in FIG. 4, the protruding partition wall 133 may include a protruding end surface 1331 positioned at an end in a direction (e.g., +z-axis direction) in which the protruding partition wall 133 protrudes, a partition wall outer surface 1332 of the partition wall 133 positioned in a direction away from the lance support 132, and a partition wall inner surface 1333 of the protruding partition wall 133 formed to face the lance support 132.

According to an embodiment, the protruding end surface 1331 and the partition wall outer surface 1332 may be formed in a shape corresponding to the partition wall accommodating groove 1112. For example, the protruding end surface 1331 may be formed to face a surface (e.g., a surface parallel to an x-y plane) of the partition wall accommodating groove 1112 perpendicular to the longitudinal direction (e.g., +/−z-axis direction) of the coupling bar 121. For example, the partition wall outer surface 1332 may be formed to face a surface of the partition wall accommodating groove 1112 positioned toward the inside of the connector housing 11. The protruding end surface 1331 and the partition wall outer surface 1332 having such a structure may reduce the issue of foreign substances (e.g., dust) being introduced from the outside of the connector assembly 1 by having a structure that engages the partition wall accommodating groove 1112. For example, components in the engaging structure described above, a surface may be in surface contact with a groove and may engage with a groove using an interference fit, but embodiments are not limited thereto, and there may be a slight gap therebetween. Although not illustrated, a waterproofing structure (e.g., an O-ring) may be disposed between components in the engaging structure described above so that a waterproofing function is performed, but embodiments are not limited thereto.

According to an embodiment, the partition wall inner surface 1333 may be formed to face one surface of the connection bar 122 of the joint terminal 12 and may help to keep the connection bar 122 aligned in the correct direction. For example, the partition wall inner surface 1333 may support the connection bar 122 by being in surface contact with one surface of the connection bar 122, but embodiments are not limited thereto.

According to an embodiment, the protruding partition wall 133 may reduce the issue of foreign substances being introduced into the connector assembly 1 from the outside and provide a structure that surrounds one side of the joint terminal 12, thereby improving the structural stability of the entire connector assembly 1.

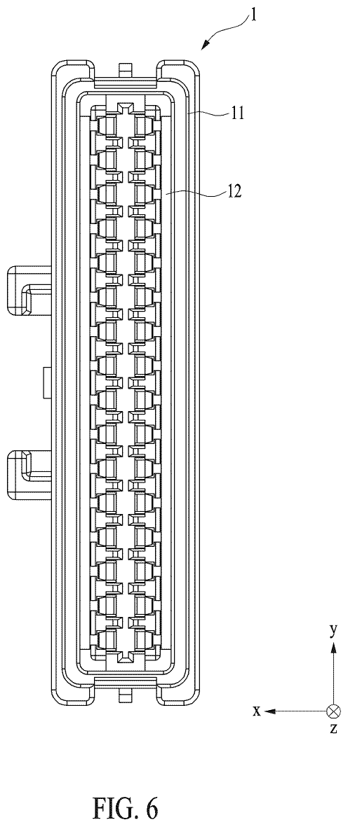

Referring to FIGS. 5-7, the bus bar support 113 according to an embodiment may include a protruding inner wall 1131, a bar seating groove 1132, the bar through groove 1133, and a bar support protrusion 1134. According to an embodiment, the protruding inner wall 1131 may protrude inwardly from the main body outer wall 1111 of the housing main body 111 to support at least one surface (e.g., three surfaces including a surface in the +y-axis direction, a surface in the −y-axis direction, and a surface in the +x-axis or −x-axis direction) in the perimeter direction of the coupling bar 121. For example, the protruding inner wall 1131 may be in surface contact with at least one surface in the perimeter direction of the coupling bar 121.

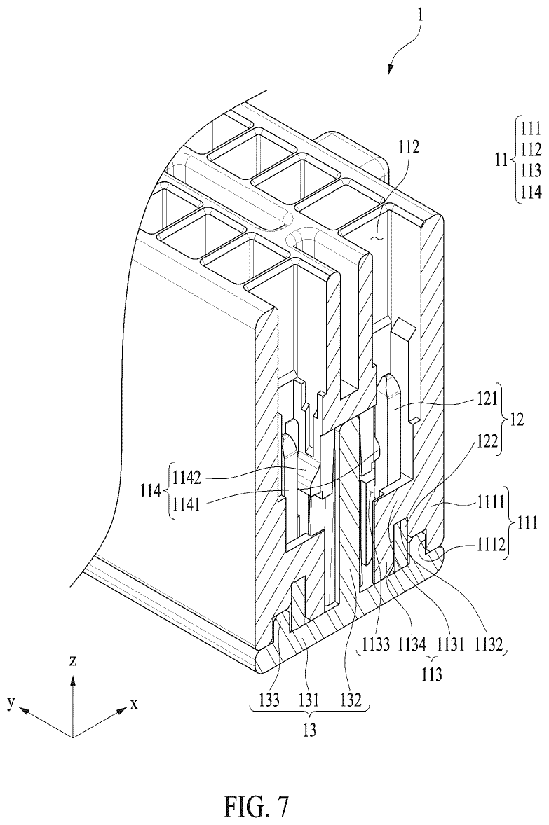

According to an embodiment, as shown in FIGS. 5 and 7, the bar seating groove 1132 may be formed in the bus bar support 113 and may accommodate the connection bar 122 of the joint terminal 12. The bar seating groove 1132 may help the joint terminal 12 maintain a stable position within the connector housing 11 by supporting the connection bar 122. For example, the bar seating groove 1132 may be recessed from the protruding inner wall 1131 in a direction (e.g., +z-axis direction) in which the joint terminal 12 is inserted into the connector housing 11. For example, the bar seating groove 1132 may be recessed from a surface of the protruding inner wall 1131 facing the cover plate 131 in a direction away from the cover plate 131 (e.g., +z-axis direction).

According to an embodiment, the bar through groove 1133 may be formed in the bus bar support 113 and may provide a space through which the coupling bar 121 of the joint terminal 12 may pass. For example, the bar through groove 1133 may be formed between a pair of bar seating grooves 1132 that are adjacent to each other among a plurality of bar seating grooves 1132. For example, the bar through groove 1133 may be connected to the bar seating groove 1132, so that the coupling bar 121 connected to the connection bar 122 seated in the bar seating groove 1132 may be inserted through the bar through groove 1133. For example, the bar through groove 1133 may be open in a direction toward the lance support 132. Even with this shape, the issue of the coupling bar 121 being separated from the bar through groove 1133 or misaligned may be reduced by the fitting portion 1211 and/or the bar support protrusion 1134.

According to an embodiment, the bar support protrusion 1134 may support a surface (e.g., a surface in the −x-axis or +x-axis direction) of the connection bar 122 facing the lance support 132. For example, the bar support protrusion 1134 may be formed to protrude from the protruding inner wall 1131 in a direction (e.g., +axis direction) opposite to the insertion direction (e.g., −z-axis direction) in which the joint terminal 12 is inserted into the connector housing 11.

For example, as illustrated in FIG. 5, the bar support protrusion 1134 may not overlap the locking lance 114 when viewed in the insertion direction (e.g., +z-axis direction) in which the joint terminal 12 is inserted into the connector housing 11. For example, a plurality of bar support protrusions 1134 may be spaced apart from one another. For example, the bar support protrusion 1134 may not be formed in a portion adjacent to the plurality of bar through grooves 1133. With this structure, it may be possible to secure an empty space surrounding the locking lance 114 positioned between a pair of bar support protrusions 1134 that are adjacent to each other among the plurality of bar support protrusions 1134. Therefore, according to an embodiment, while providing a structure capable of stably supporting the joint terminal 12 through the bar support protrusion 1134, it may be possible to improve yield of good quality of the connector housing 11 and reduce the overall manufacturing cost.

For example, as illustrated in FIG. 7, when viewed in the insertion direction (e.g., +z-axis direction) in which the joint terminal 12 is inserted into the connector housing 11, an end of the locking lance 114 protruding into the cable insertion groove 112 may not overlap the remaining portion of the connector housing 11. Since the locking lance 114 having such a structure may be manufactured by injection molding using only two molds without a slide core, the manufacturing cost may be reduced.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents. Therefore, other implementations, other embodiments, and equivalents of the claims are within the scope of the following claims.

1. A connector assembly, comprising:
a connector housing including a housing main body, a plurality of cable insertion grooves formed in the housing main body and respectively accommodating a plurality of external connection cables, a locking lance protruding into the plurality of cable insertion grooves to reduce separation of the plurality of external connection cables from the plurality of cable insertion grooves, a retreat space providing a space allowing the locking lance to elastically deform and retreat so that the plurality of external connection cables is insertable into the plurality of cable insertion grooves, and a bus bar support protruding inward from an inner wall of the housing main body;
a joint terminal including a plurality of coupling bars respectively passing through a plurality of bar through grooves formed in the bus bar support and respectively coupled to the plurality of external connection cables, and a connection bar physically and electrically connecting the plurality of coupling bars and seated in a bus bar seating groove formed in the bus bar support; and
a connector cover including a cover plate closing one side of each of the plurality of cable insertion grooves and a lance support protruding from the cover plate and inserted into the retreat space to reduce elastic deformation of the locking lance in a direction of separation from the plurality of external connection cables.

2. The connector assembly of claim 1, wherein the locking lance includes a first lance portion having a shape protruding from a center of the housing main body to one side of the inner wall of the housing main body.

3. The connector assembly of claim 2, wherein the locking lane includes a second lance portion having a shape protruding from the center of the housing main body to another side of the inner wall of the housing main body positioned opposite to the one side of the inner wall.

4. The connector assembly of claim 3, wherein the retreat space is formed between the first lance portion and the second lance portion.

5. The connector assembly of claim 1, wherein the connector cover includes a protruding partition wall protruding from the cover plate.

6. The connector assembly of claim 5, wherein the housing main body includes a main body outer wall forming an exterior of the connector housing and a partition wall accommodating groove stepped inward from the main body outer wall to accommodate the protruding partition wall, the partition wall accommodating groove has a shape facing each of a protruding end surface and a partition wall outer surface of the protruding partition wall.

7. The connector assembly of claim 1, wherein the housing main body has a main body outer wall forming an exterior of the connector housing.

8. The connector assembly of claim 7, wherein the bus bar support has a protruding inner wall protruding inward from the main body outer wall and supporting at least one surface of a perimeter surface of one of the coupling bars.

9. The connector assembly of claim 8, wherein the bus bar support includes a bar support protrusion protruding from the protruding inner wall in a direction opposite to an insertion direction in which the joint terminal is inserted into the connector housing and supporting the at least one surface of the perimeter surface of the coupling bar.

10. The connector assembly of claim 9, wherein the bar support protrusion supports a surface of the connection bar facing the lance support.

11. The connector assembly of claim 9, wherein the bar support protrusion does not overlap the locking lance when viewed in the insertion direction.

12. The connector assembly of claim 11, wherein the bar support protrusion is one of a plurality of bar support protrusions spaced from one another.

13. The connector assembly of claim 11, wherein the bar support protrusion is not formed in a portion adjacent to the plurality of bar through grooves.

14. The connector assembly of claim 1, wherein, when viewed in an insertion direction in which the joint terminal is inserted into the connector housing, an end of the locking lance protruding into the plurality of cable insertion grooves does not overlap a remaining portion of the connector housing.

15. The connector assembly of claim 1, wherein the connector housing does not have a hole formed in a direction perpendicular to an insertion direction in which the joint terminal is inserted into the connector housing.

16. The connector assembly of claim 1, wherein a shortest distance from the coupling bars to an inner wall of the connector housing, excluding the bus bar support, is less than a shortest distance from the coupling bars to the locking lance.
